(19) United States
(12) Patent Application Publication
(10) Pub. No.: US 2011/0113976 A1
(43) Pub. Date: May 19, 2011

(54) SECURITY PRINTING WITH CURABLE TONERS

(75) Inventor: Michael Donald Thompson, Rochester, NY (US)

(73) Assignee: XEROX CORPORATION, Norwalk, CT (US)

(21) Appl. No.: 12/620,835

(22) Filed: Nov. 18, 2009

(51) Int. Cl. B41F 19/02; B31F 1/07

(52) U.S. Cl. 101/27; 101/32

(57) ABSTRACT

A system and accompanying method for creating a securely printed document using curable toners. The system includes a first radiation source configured to expose a first radiation to a printing substrate having an applied amount of toner, thereby liquefying the toner into a molten state, a curing station, a first feeder configured to feed the printing substrate into the curing station, and a second feeder configured to feed the embossing substrate into the curing station, wherein the embossing substrate comprises a pattern to be imprinted into the toner. The curing station includes a combiner configured to press the printing substrate and an embossing substrate together, a second radiation source configured to expose a second radiation to the combined substrates, and a divider configured to separate the printing substrate from the embossing substrate.

### BACKGROUND

The present disclosure relates to manufacture of printed packages or secure documents. More specifically, the present disclosure relates to secure printing by embossing patterns or signatures into a printed package or packing seal.

Counterfeiting is a serious problem affecting nearly all aspects of the manufacturing industry. In efforts to prevent counterfeiting, many manufacturers have started to add security features to packaging. One security feature involves branding, or stamping, a product with a licensed image or trademark that indicates the manufactured item is a genuine product of the manufacturer. However, this approach merely slows counterfeiters while they also change their manufacturing processes and techniques to duplicate the changes made by the genuine manufacturers.

Counterfeiting is particularly widespread in the pharmaceutical industry. With the advance of foreign manufacturers and Internet pharmacies, counterfeit medications are becoming a serious threat to the pharmaceutical industry. Counterfeit drugs are sometimes made from different or inferior products that could cause detrimental effects in a patient. In some extreme cases, a patient could even die after receiving a counterfeit medication that is not correctly manufactured or is incorrectly labeled.

To avoid confusion with counterfeited goods, many pharmaceutical companies manufacture custom packaging with printed seals, which indicate authenticity. These printed seals enclose the caps or lids of the medication bottles, and include a stamp or printed item from the manufacturer. However, counterfeiters began copying the printed seals as well, thereby producing accurate packaging containing counterfeit medications.

### SUMMARY

The invention described in this document is not limited to the particular systems, methodologies or protocols described, as these may vary. The terminology used herein is for the purpose of describing particular embodiments only, and is not intended to limit the scope of the present disclosure.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In one general respect, the embodiments disclose a method of embossing toner. The method includes the steps of applying toner to a print substrate, applying an embossing substrate to the toner wherein the embossing substrate imprints a pattern into the toner, melting the toner via a first radiation source such that the toner is liquefied to a molten state, curing the toner via a second radiation source such that an imprint of the pattern is embossed in the toner, and removing the embossing substrate.

In another general respect, the embodiments disclose a system for creating a securely printed document. The system includes a first radiation source configured to expose a first radiation to a printing substrate having an applied amount of toner, thereby liquefying the toner into a molten state, a curing station, a first feeder configured to feed the printing substrate into the curing station, and a second feeder configured to feed the embossing substrate into the curing station, wherein the embossing substrate comprises a pattern to be imprinted into the toner. The curing station includes a combiner configured to press the printing substrate and an embossing substrate together, a second radiation source configured to expose a second radiation to the combined substrates, and a divider configured to separate the printing substrate from the embossing substrate.

In another general respect, the embodiments disclose a method of embossing toner. The method includes the steps of creating a predetermined pattern on an embossing substrate, applying toner to a print substrate, melting, via a first radiation source, the applied toner to liquefy the toner to a molten state, applying the embossing substrate to the toner, wherein the embossing substrate imprints the pattern into toner, and curing, via a second radiation source, the ink such that an imprint of the pattern is embossed in the toner.

### BRIEF DESCRIPTION OF THE DRAWINGS

Aspects, features, benefits and advantages of the present invention will be apparent with regard to the following description and accompanying drawings, of which:

FIG. 1 illustrates various embodiments of a printing and embossing configuration;

FIG. 2 illustrates various embodiments of a manufacturing assembly including the printing and embossing configuration of FIG. 1;

FIG. 3 illustrates various embodiments of a printing and embossing method;

FIG. 4 illustrates various embodiments of a manufacturing assembly including an alternative printing and embossing configuration; and

FIG. 5 illustrates various embodiments of an alternative printing and embossing method.

### DETAILED DESCRIPTION

For purposes of the discussion below, an “assembly” refers to a printer, a copier, a multifunction machine or system, a xerographic machine or system, or any other type of printing apparatus that is capable of applying and curing a toner on a printing substrate.

A “printing substrate” refers to a physical sheet of paper, plastic and/or other suitable substrate for printing text and/or images thereon.

An “embossing substrate” refers to a physical sheet of paper, plastic and/or other suitable substrate for embossing a pattern into an amount of toner applied to a printing substrate.

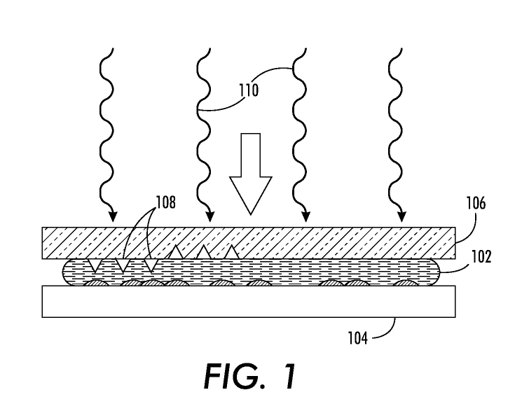

FIG. 1 illustrates a side view of one embodiment of a printing and embossing configuration. The configuration may be implemented at a toner curing station (e.g., an ultraviolet (UV) curing station, a thermal heating station, or a combination of multiple curing and thermal sources). An amount of toner 102 is applied to a print substrate 104. The toner 102 may then be heated to a molten state. An embossing substrate 106 is applied on top of the toner 102, sandwiching the molten toner between the print substrate 104 and the embossing substrate. A downward pressure is applied to the embossing substrate 106, illustrated in FIG. 1 by the arrow. The embossing substrate 106 may contain a series of impressions and/or depressions 108. The impressions/depressions 108 may be used to create security features in a predetermined pattern on the embossing substrate 106 which is then imprinted or embossed into the toner 102. The security features may include, for example, lines having a thickness of no more than ten microns arranged in a purposefully determined pattern.

Another component of the printing and embossing configuration illustrated in FIG. 1 is a radiation source 110. The radiation source 110 may be configured to produce a first radiation (e.g., a thermal radiation such as heat) and a second curing radiation (e.g., an electromagnetic radiation such as ultraviolet (UN) light). In an exemplary embodiment, the first radiation is heat, and the second curing radiation is UV light. The radiation source 110 is arranged such that both the heat and the UV light may be directed through the embossing substrate 106 toward the toner 102. It is important to note that when using a radiation source such as the UV light radiation of the radiation source 110, the embossing substrate 106 should be made from a material that is transparent to the radiation, e.g., UV light, that is intended to pass through the substrate. Similarly, when using a thermal radiation source such as a heat source 110, the embossing substrate 106 should be made from a material that provides little or no insulation from heat reaching the toner 102. If the embossing substrate 106 is not transparent to the radiation, the toner 102 will not cure. It should be noted that the toner 102 may be indirectly heated as well through heating of the printing substrate 104 and/or the embossing substrate 106.

After curing, the embossing substrate 106 is removed to reveal the printing substrate 104 having the cured toner 102. The toner 102, having been cured, becomes crosslinked and therefore allows the security feature to remain in a durable state.

Various types of curable toners may be used. One example of a curable toner is a UV curable toner, such as the toner described in U.S. Pat. No. 7,250,238, the disclosure of which is hereby incorporated by reference. A UV toner has a composition such that, when exposed to UV radiation, such as light having a wavelength of about 100 nm to about 400 nm, the toner cures. UV curing enables toner to be cured, thus resulting in a toner image that is more durable than a non-cured toner image. These cured toner images are more resistant to high temperatures, solvents, and other drawbacks that may degrade the quality of non-cured toner images.

The embossing substrate 106 may be made from a material transparent to any curing radiations used. For example, the embossing substrate 106 may be made from a clear, or semi-transparent material such that the UV light passes there through. The embossing substrate 106 may also be made from a material that is easily removed from the printing substrate 104 and the toner 102, such as clear TEFLON® tape or UV transparent acrylic.

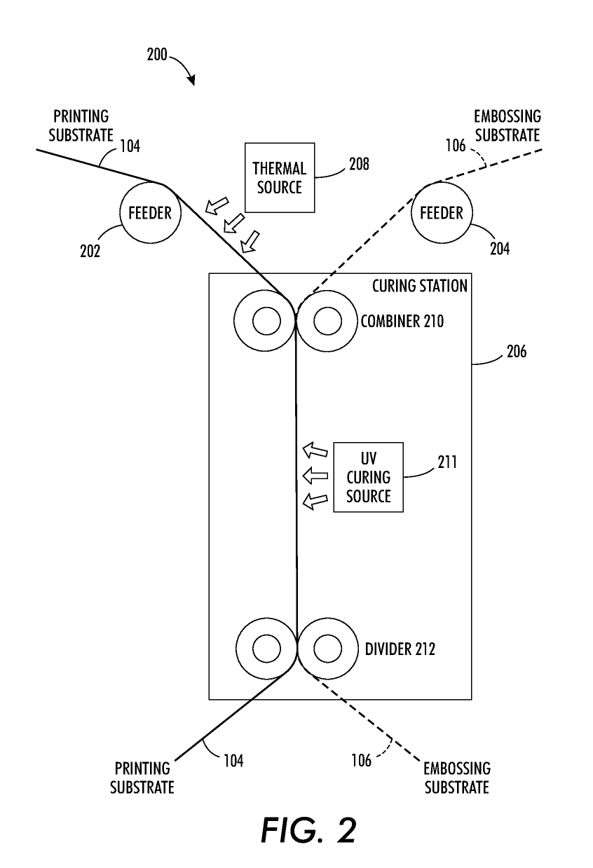

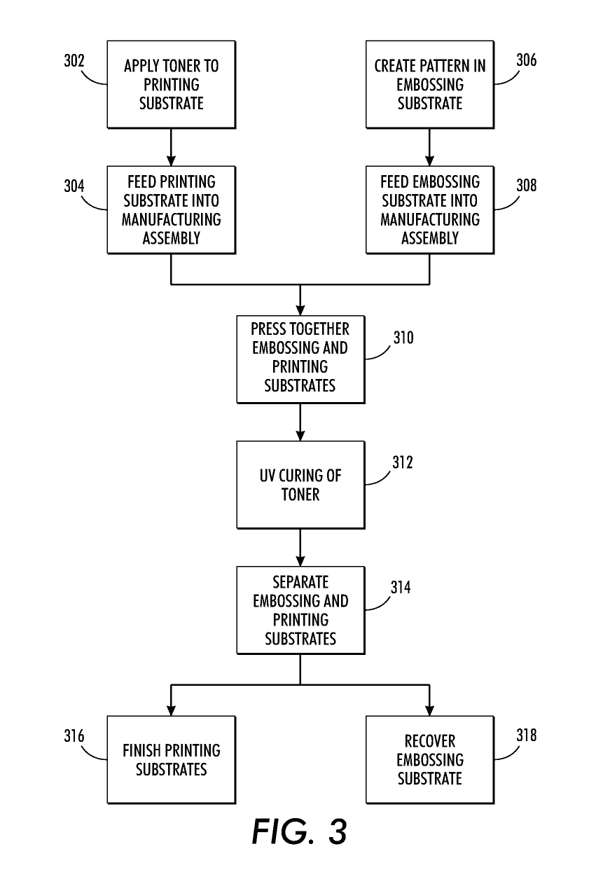

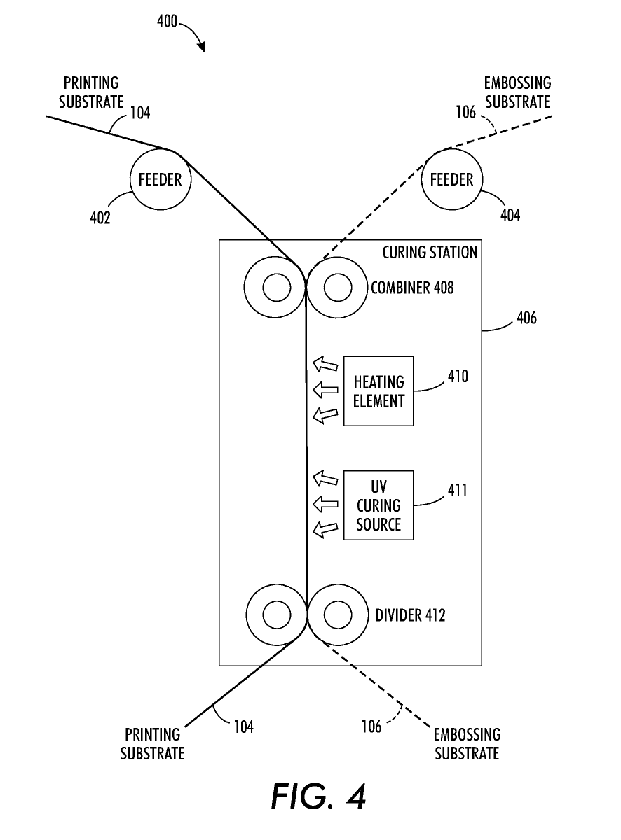

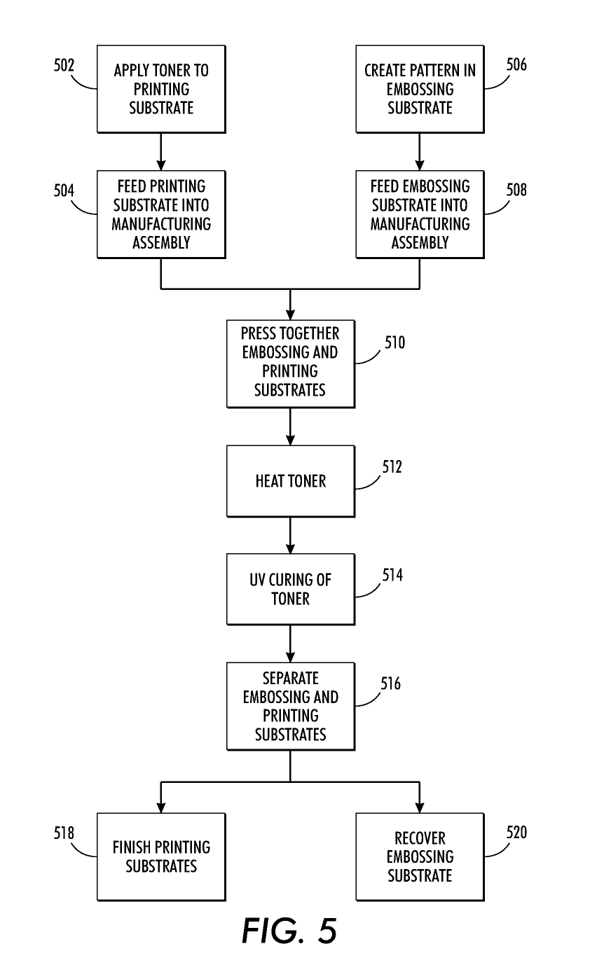

It should be noted that two separate radiations sources may be used. A first radiation source may be used to apply the first radiation to the toner, thereby liquefying the toner to a molten state. A second radiation source may then be used to apply the second radiation to the toner, thereby curing the toner into a solid with the embossing pattern cured into the toner. The printing, embossing and curing mechanisms and methods are discussed in greater detail in the following discussions of FIG. 2 and FIG. 3. Similarly, an amount of toner may already be cured on a printing substrate before the application of an embossing substrate. In this example, the cured toner may be reheated and liquefied into a molten state, embossed, and cured with a second radiation such as UV light. Alternative printing, embossing and curing methods are discussed in greater detail in the following discussions of FIG. 4 and FIG. 5.

FIG. 2 illustrates a manufacturing assembly 200 including an embodiment of the printing and embossing configuration illustrated in FIG. 1. The manufacturing assembly 200 may be used to produce a printed security seal, document, or any printed materials including toner embossed with a unique pattern.

The manufacturing assembly 200 includes two material pathways, one for the printing substrate 104 and one for the embossing substrate 106. The printing substrate 104 enters the assembly 200 via a feeder 202. The feeder 202 may include one or more rotating devices, such as a transport nip, designed to rotate and propel a substrate in a particular direction. In this example, the feeder 202 rotates clockwise and propels the printing substrate 104 through the assembly 200. Similarly, the embossing substrate 106 enters the assembly 200 via a feeder 204. The feeders 202, 204 feed their respective substrates into a curing station 206. In this example, an amount of the toner 102 is already applied to the printing substrate 104; however, an additional component may be present in the manufacturing assembly for applying the toner. Similarly, in this example, the pattern of impressions and/or depressions 108 is already applied to the embossing substrate 106; however, an additional component may be present in the manufacturing assembly for creating the pattern on the embossing substrate.

The manufacturing assembly 200 may further include a thermal radiation source 208 for liquefying the toner into a molten state, typically at a temperature of about 70° C. to 100° C. The curing station 206 may include a combiner 210, a UV curing source 211 for curing the toner and a divider 212. In an embodiment, the thermal radiation source 208 may include a heat producing source such as those discussed above in reference to FIG. 1, the heat being directed at the printing substrate 104 such that the applied toner is liquefied into a molten state. The combiner 210 may receive the printing substrate 104 while the toner is still in a molten state and the embossing substrate 106 and may press the substrates together such that any impressions and/or depressions in the embossing substrate are imprinted into the molten toner. Similar to the feeders 202, 204, the combiner 210 may include a plurality of transport nips, or other rotating devices, positioned such that the substrates 104, 106 are pressed together, sandwiching the toner 102 between the two substrates as the substrates pass through the combiner. The UV curing source 211 may include a UV light producing source, such as those discussed above in reference to FIG. 1. For example, the UV curing source 211 may produce UV light having a wavelength of about 100 nm to about 400 nm. The UV curing source 211 may direct its radiation toward the combined printing substrate 104 and embossing substrate 106 such that the molten toner 102 is cured by the UV light. The divider 212 separates the pressed together substrates 104, 106 resulting in the printing substrate with the cured and embossed toner 102 and the used embossing substrate. The divider 212 may include a plurality of transport nips, or other rotating devices, positioned such that the substrates 104, 106 are divided as the substrates pass through the divider. The steps that may be taken during the manufacturing, and resulting printing and embossing, are discussed below in greater detail with regard to FIG. 3.

FIG. 3 illustrates an exemplary flowchart illustrating the steps taken during the manufacturing process performed by the manufacturing assembly 200. The flowchart illustrates the two separate paths taken by the separate substrates. The printing substrate is illustrated on the left of the flowchart, the embossing substrate is illustrated on the right on the flowchart and common steps are illustrated in the middle of the flowchart.

As shown in FIG. 3, the toner is applied 302 to the printing substrate. During toner application, the toner is first deposited on the printing substrate and heated via a thermal radiation source to a molten state. It should be noted the amount of toner applied 302 to the printing substrate may be determined by the pattern to be embossed.

After the toner is applied 302 to the printing substrate, the printing substrate is fed 304 into the manufacturing assembly. For this example, printing substrate 104 (including applied toner 102) may be fed 304 into the manufacturing assembly 200 by the feeder 202.

As further shown in FIG. 3 a pattern is created 306 in the embossing substrate. It should be noted that this may be done in advance of the manufacturing process as the creation of the pattern in the embossing substrate may utilize a large number of operations. In an embodiment, the pattern may be created 306 by a micro-dot printing technique. In micro-dot printing, tiny drops of ink are printed onto a surface in a pattern. The individual drops of ink may be 1 nm or less in diameter. To the naked eye, the individual printed drops of ink would just appear to be a single larger ink dot, or a series of larger ink dots. However, with additional magnification, the pattern created by the individual ink drops may be seen. The drops dry slightly on the surface of the embossing substrate as opposed to being absorbed into the embossing substrate, thereby providing a pattern that may be embossed into the toner on the printing substrate. To ensure the integrity of the ink drops on the embossing substrate during the curing of the toner, an ink may be used that is resistant to both heat and UV radiation.

By using micro-dot printing, a manufacturing company can quickly change the pattern on the embossing substrate by changing the design of the micro-dot pattern. Similarly, a pattern may be scratched or etched into the embossing substrate. Once the pattern is created 306 on the embossing substrate, the embossing substrate is wound onto a reel for feeding into the manufacturing assembly.

Once the pattern is created and the embossing substrate is wound, the embossing substrate may be unwound from the reel and fed 308 into the manufacturing assembly. To continue the example discussed above, embossing substrate 106 (including impressions/depressions 108) may be fed 308 into the manufacturing assembly 200 by the feeder 204.

When both substrates (i.e., printing and embossing) are fed into the assembly, the two substrates are pressed together 310 to enclose the molten toner on two opposite sides, sandwiching the molten toner between the two substrates. The two substrates proceed through the manufacturing assembly simultaneously at a substantially similar speed. In the present example, the printing substrate 104 may be pressed together 310 with the embossing substrate 106 by combiner 210 of the manufacturing assembly 200, thereby sandwiching the molten toner 102 between the two substrates.

Once the substrates are pressed together 310, the combined substrates are exposed to a radiation source, and the toner applied to the printing substrate may be cured 312. Continuing with the present example, the combined substrates reach the UV curing source 211 of the manufacturing assembly 200. UV light produced by UV curing source 211 passes through the embossing substrate 106 and cures 312 the molten toner 102. During the curing process, any pattern included on the embossing substrate 106 (e.g., impressions/depressions 108) is embossed into the molten toner 102. As it cures 312, the molten toner 102 undergoes a molecular change from a monomer to a polymer. During the curing 312, the toner particles form interconnecting bonds, thereby adding a rigidity to the toner 102, resulting in a cured toner.

The two substrates may then be separated 314. To continue with the above example, the substrates continue through the manufacturing assembly 200 to the divider 212 where the substrates are separated 314.

The process illustrated in FIG. 3 again splits into two paths, one for each substrate. Finishing operations may be performed 316 on the printing substrate. For example, the printing substrate may be cut to appropriate lengths for labels, have an adhesive applied to create a seal, and/or various other finishing operations.

The embossing substrate may be recovered 318 and re-wound onto a roll. Depending on the condition of the embossing substrate, and the desires of the manufacturer, the embossing substrate may be re-used for the embossing of another length of printing substrate.

An alternative method of printing and embossing is discussed in the following discussions of FIGS. 4 and 5. In this alternative method, the toner may already be thermally fused onto the printing substrate before the embossing substrate is applied. This method may include liquefying the applied toner into a molten state again before curing the toner with the UV light.

FIG. 4 illustrates a manufacturing assembly 400 including an embodiment of the printing and embossing configuration illustrated in FIG. 1. The manufacturing assembly 400 may be used to produce a printed security seal, document, or any printed materials including toner embossed with a pattern.

The manufacturing assembly 400 includes two material pathways, one for the printing substrate 104 and one for the embossing substrate 106. In this example, an amount of toner 102 has already been deposited on the printing substrate 104, been previously heated with a thermal source to a molten state, and has hardened on the printing substrate. The printing substrate 104 enters the manufacturing assembly 400 via a feeder 402. Similarly, the embossing substrate 106 enters the manufacturing assembly 400 via a feeder 404. The feeders 402, 404 feed their respective substrates into a curing station 406. In this example, the pattern of impressions and/or depressions 108 (as shown in FIG. 1) is already applied to the embossing substrate 106; however, an additional component may be present in the manufacturing assembly for creating the pattern on the embossing substrate.

The curing station 406 may include a combiner 408, a heating element 410 for liquefying the dried toner 102 on the printing substrate 104 into a molten state, a UV curing source 411 for curing the toner and a divider 412. The heating source 410 may be similar to the thermal radiation source 208 as shown in FIG. 2, configured to produce and direct heat toward the combined substrates such that the toner 102 is liquefied and the pattern on the embossing substrate 106 is pressed into the molten toner. The UV curing source 411 may include a UV light producing curing source such as those discussed above in reference to FIG. 1. The UV curing source may be directed at the printing substrate 104 and embossing substrate 106 while they are pressed together such that the molten toner is cured by the UV light. The divider 412 separates the substrates 104, 106 resulting in both the printing substrate with the cured and embossed toner 102 and the used embossing substrate. The actual steps taken during the manufacturing, and resulting printing and embossing, are discussed below in greater detail with regard to FIG. 5.

FIG. 5 illustrates an exemplary flowchart illustrating the steps taken during the manufacturing process performed by the manufacturing assembly 400. The flowchart illustrates the two separate paths taken by the separate substrates. The printing substrate is illustrated on the left of the flowchart, the embossing substrate is illustrated on the right on the flowchart and common steps are illustrated in the middle of the flowchart.

As shown in FIG. 5, an amount of toner is already deposited on and thermally fused 502 to the printing substrate. During toner application, the toner is first deposited on the printing substrate and heated via a thermal radiation source to a molten state. It should be noted that the amount of the toner deposited and fused 502 may be determined by the pattern to be embossed.

After the toner is deposited on and fused 502 to the printing substrate, the printing substrate is fed 504 into the manufacturing assembly. For this example, the printing substrate 104 (including fused toner 102) may be fed 504 into the manufacturing assembly 400 by the feeder 402.

As further shown in FIG. 5, a pattern may be created 506 in the embossing substrate. Once the pattern is created 506 on the embossing substrate, the embossing substrate is wound onto a reel for feeding into the manufacturing assembly.

Once the pattern is created and the embossing substrate is wound, the embossing substrate may be unwound from the reel and fed 508 into the manufacturing assembly. To continue the example discussed above, embossing substrate 106 (including impressions/depressions 108) may be fed 508 into the manufacturing assembly 400 by the feeder 404.

When both substrates (i.e., printing and embossing) are fed into the assembly, the two substrates are pressed together 510 to enclose the dried toner on two opposite sides, sandwiching the dried toner between the two substrates. The two substrates proceed through the manufacturing assembly simultaneously at a substantially similar speed. In the present example, the printing substrate 104 may be pressed together 510 with the embossing substrate 106 by combiner 408 of the manufacturing assembly 400, thereby sandwiching the dried toner 102 between the two substrates.

Once the substrates are pressed together 510, the combined substrates pass a heating element where the previously fused toner is reheated 512 once again to a molten state. Once back in the molten state, the predetermined pattern on the embossing substrate may be pressed into the molten toner, thereby transferring the predetermined pattern into the toner. Continuing with the present example, the combined substrates pass the heating element 410 of the manufacturing assembly 400 where the previously fused toner 102 is reheated 512 again to a molten state. Once the toner 102 is reheated, the substrates pass the UV curing source 411 of the manufacturing assembly 400. UV light produced by UV curing source 411 passes through the embossing substrate 106 and cures 514 the molten toner 102. During the curing process, any pattern included on the embossing substrate 106 (e.g., impressions/depressions 108) is embossed into the molten toner 102. As it cures 514, the molten toner 102 undergoes a molecular change from a monomer to a polymer. During the curing 514, the toner particles form interconnecting bonds, thereby adding a rigidity to the toner 102, resulting in a cured toner image.

The two substrates may then be separated 516. To continue with the above example, the substrates continue through the manufacturing assembly 400 to divider 412 where the substrates are separated 516.

The process illustrated in FIG. 5 again splits into two paths, one for each substrate. Finishing operations may be performed 518 on the printing substrate. For example, the printing substrate may be cut to appropriate lengths for labels, have an adhesive applied to create a seal, and/or various other finishing operations.

The embossing substrate may be recovered 520 and re-wound onto a roll. Depending on the condition of the embossing substrate, and the desires of the manufacturer, the embossing substrate may be re-used for the embossing of another length of printing substrate.

It should be noted that the above processes and assemblies provide a manufacturing environment in which security and control features may be quickly and easily altered. By simply changing the pattern of the embossing substrate, a new security feature may be added to the printed substrate. This may enable a manufacturer to quickly change the security features provided with a product should a counterfeiter find a way to reproduce the original pattern embossed in the toner.

For example, a pharmaceutical company may emboss a pattern into the seals they include on their products by using the process described above. For security, every month (or any desired period of time), the manufacturer may change the pattern of the embossing substrate, thereby resulting in an updated seal with a new security feature. By providing pharmacies (or other end users) with an indication of what the updated security feature is, counterfeiting may be reduced because pharmacies will know what security features to look for in genuine products. Similarly, by changing the security feature often, counterfeiters would not have an opportunity to duplicate the security feature because the genuine manufacturer may have changed the security feature by the time the counterfeit products with a copied security feature reach the market.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of embossing toner, the method comprising:
applying toner to a print substrate;
applying an embossing substrate to the toner wherein the embossing substrate imprints a pattern into the toner;
melting the toner via a first radiation source such that the toner is liquefied to a molten state;
curing the toner via a second radiation source such that an imprint of the pattern is embossed in the toner; and
removing the embossing substrate.

2. The method of claim 1, wherein the melting the toner via a first radiation source comprises melting the toner via a thermal radiation source such that the toner is liquefied to a molten state.

3. The method of claim 1, wherein the curing the toner via a second radiation source comprises curing the toner via an ultraviolet radiation source such that an imprint of the pattern is embossed in the toner.

4. The method of claim 1, wherein the applying the embossing substrate to the toner further comprises applying at least one of an impression and a depression into the toner, thereby transferring a pattern created by the at least one of an impression and a depression into the toner.

5. The method of claim 1, wherein the applying the embossing substrate to the toner further comprises applying a series of micro-dot printed ink drops into the toner, thereby transferring a pattern created by the micro-dot printed ink drops to the toner.

6. A system for creating a securely printed document, the system comprising:
a first radiation source configured to expose a first radiation to a printing substrate having an applied amount of toner, thereby liquefying the toner into a molten state;
a curing station, comprising:
a combiner configured to press the printing substrate and an embossing substrate together,
a second radiation source configured to expose a second radiation to the combined substrates, and
a divider configured to separate the printing-substrate from the embossing substrate;
a first feeder configured to feed the printing substrate into the curing station; and
a second feeder configured to feed the embossing substrate into the curing station, wherein the embossing substrate comprises a pattern to be imprinted into the toner.

7. The system of claim 6, wherein the combiner is further configured to:
press the printing substrate and the embossing substrate together such that the molten toner is between the printing substrate and the embossing substrate.

8. The system of claim 6, wherein the divider is further configured to:
separate the printing substrate from the embossing substrate such that the applied toner remains on the printing substrate.

9. The system of claim 6, wherein the first radiation source is a thermal radiation source.

10. The system of claim 6, wherein the second radiation source is an ultraviolet radiation source.

11. The system of claim 6, wherein the embossing substrate comprises at least one of an impression and a depression, thereby creating the pattern to be imprinted into the toner.

12. The system of claim 6, wherein the embossing substrate comprises a series of micro-dot printed ink drops, thereby creating the pattern to be imprinted into the toner.

13. A method of embossing toner, the method comprising:
creating a predetermined pattern on an embossing substrate;
applying toner to a print substrate;
melting, via a first radiation source, the applied toner to liquefy the toner to a molten state;
applying the embossing substrate to the toner, wherein the embossing substrate imprints the pattern into toner; and
curing, via a second radiation source, the ink such that an imprint of the pattern is embossed in the toner.

14. The method of claim 13, wherein the melting, via a first radiation source, comprises melting the toner via a thermal radiation source such that the toner is liquefied to a molten state.

15. The method of claim 13, wherein the curing, via a second radiation source, comprises curing the toner via an ultraviolet radiation source such that an imprint of the pattern is embossed, in the toner.

16. The method of claim 13, wherein the applying the embossing substrate to the toner further comprises applying at least one of an impression and a depression into the toner, thereby transferring a pattern created by the at least one of an impression and a depression into the toner.

17. The method of claim 13, wherein the applying the embossing substrate to the toner further comprises applying a series of micro-dot printed ink drops into the toner, thereby transferring a pattern created by the micro-dot printed ink drops to the toner.
